(19) United States
(12) Patent Application Publication
(10) Pub. No.: US 2019/0058312 A1
(43) Pub. Date: Feb. 21, 2019

(54) ELECTRIC-FLAME-OFF STRIPPED MICRO COAXIAL WIRE ENDS

(71) Applicant: The Charles Stark Draper Laboratory, Inc., Cambridge, MA (US)

(72) Inventors: Mitchell W. Meinhold, Cambridge, MA (US); Caprice Gray Haley, Cambridge, MA (US); Sara C. Barron, Cambridge, MA (US)

(21) Appl. No.: 16/102,056

(22) Filed: Aug. 13, 2018

Related U.S. Application Data
(60) Provisional application No. 62/545,561, filed on Aug. 15, 2017.

(51) Int. Cl. H02G 1/12; H01R 43/01; H01R 43/05; H01B 11/18

(52) U.S. Cl. CPC H02G 1/128; H01R 43/015; H01B 11/1895; H02G 1/1282; H01R 43/05

(57) ABSTRACT

Disclosed are systems, devices, apparatus, tools, coaxial cables, materials, methods, and other implementations that include a method comprising controllably stripping, through one or more applications of energy directed at a micro coaxial cable, a conductive shield layer of the micro coaxial cable to expose a portion of a core conductive wire of the micro coaxial wire, and controllably deforming the exposed portion of the core conductive wire of the micro coaxial wire through the one or more applications of energy.

### CROSS-REFERENCE TO RELATED APPLICATIONS

This application claims the benefit of U.S. Provisional Application 62/545,561, filed on Aug. 15, 2017, the contents of which is incorporated herein by reference.

### BACKGROUND

Wiring interconnection technologies require the quick and efficient stripping and bonding of wires to create electrical connections between different points and components. In the case of coaxial (also referred to as “coax”) cables (wires), there are different stripping systems that are available to strip fine coax wire. An example of such systems includes a rotary blade system. In rotary blade systems, two or more radially positioned cutting blades are closed down at a given diameter as they spin around the cable. A drawback of such a system is that a separate mechanical stripping tool is needed to be attached to the bonding tool, resulting in a complex (and bulky) mechanical implementation.

### SUMMARY

In a general aspect, a method is disclosed that includes controllably stripping, through one or more applications of energy directed at a micro coaxial cable, a conductive shield layer of the micro coaxial cable to expose a portion of a core conductive wire of the micro coaxial wire, and controllably deforming the exposed portion of the core conductive wire of the micro coaxial wire through the one or more applications of energy.

Embodiments of the method may include at least some of the features described in the present disclosure, including one or more of the following features.

The method may further include deforming a portion of the stripped conductive shield layer to form a resultant thickened shield portion of the conductive shield layer configured to be coupled to a first electrical connection point located near the micro coaxial cable. Controllably deforming the exposed portion of the core conductive wire may include forming a resultant thickened core portion of the core conductive wire configured to be coupled to a second electrical connection point located near the micro coaxial cable.

The one or more applications of energy may include one or more electrical sparks directed at the micro coaxial cable. The method may further include steering the one or more electrical sparks using an electromagnetic-based steering mechanism.

Controllably stripping the conductive shield layer and controllably deforming the exposed portion of the core conductive wire may include controllably applying the one or more applications of energy based on one or more of, for example, materials used for the conductive shield layer and the core conductive wire, location of an energy applying device configured to apply the one or more applications of energy, power and duration characteristics of the one or more applications of energy, geometry of the micro coaxial cable, location of grounding points to define one or more energy paths for the one or more applications of energy, measured environmental conditions, and/or measured state values for the micro coaxial cable.

Controllably stripping the conductive shield layer may include placing one or more electrical contacts at a first location proximate the conductive shield layer, and directing a first electrical current via a first path defined, in part, by the conductive shield layer and the one or more electrical contacts placed at the first location proximate the conductive shield layer. Controllably deforming the core conductive wire may include placing at least one electrical contact at a second location proximate the core conductive wire, and directing a second electrical current via a second path defined, in part, by the core conductive wire and the at least one electrical contact placed at the second location proximate the core conductive wire.

The micro coaxial wire may further include an insulating layer disposed between the core conductive wire and the conductive shield layer, with the insulating layer configured to be at least partly stripped, through the one or more applications of energy, subsequent to the stripping of the conductive shield layer so as to expose an uninsulated portion of the core conductive wire.

The insulating layer may include one or more of, for example, a polyimide layer surrounding the core conductive wire, a polyurethane layer surrounding the core conductive wire, and/or an inorganic oxide.

The conductive shield layer may be associated with a first melting temperature and the core conductive wire may be associated with a second melting temperature, with the first melting temperature being lower than the first melting temperature.

The conductive shield layer may include a first material comprising gold, and the core conductive wire may include a second material comprising copper.

The micro coaxial wire may further include a cladding layer disposed between the core conductive wire and the conductive shield layer, with the cladding layer configured to remain substantially intact in response to the one or more applications of energy to the micro coaxial cable, with at least a portion of the cladding layer configured to break upon deformation of the exposed portion of the core conductive wire of the micro coaxial cable.

The cladding layer may include a cladding material comprising one or more of, for example, nickel and/or tungsten.

The method may further include forming the cladding layer through the one or more applications of energy that causes a chemical reaction of a cladding material with other materials at or near the micro coaxial cable.

In some variations, a micro coaxial cable is provided that includes a conductive shield layer structured so that, upon one or more applications of energy directed at the micro coaxial cable, at least a portion of the conductive shield layer is stripped, and a core conductive wire, disposed proximate the conductive shield layer, structured so that a portion of a region of the core conductive wire is exposed when the at least the portion of the conductive shield layer is stripped, and is subsequently deformed as a result of at least one of the one or more applications of energy directed at the micro coaxial cable.

Embodiments of the micro coaxial cable may include at least some of the features described in the present disclosure, including at least some of the features described above in relation to the method, as well as one or more of the following features.

The at least the portion of the conductive shield layer may be structured to be stripped upon a first application of energy is directed the micro coaxial cable, and the exposed portion of the region of the core conductive wire may be structured to be deformed upon a second application of energy directed at the micro coaxial cable.

The stripped at least the portion of the conductive shield layer may be further structured to be deformed, through the one or more applications of energy, to form a resultant thickened shield portion, configured to be coupled to a first electrical connection point located near the micro coaxial cable. The core conductive wire structured so that the exposed portion of the region of the core conductive wire is deformed as the result of the at least one of the one or more applications of energy may be structured so that the exposed portion of the region of the core conductive wire is deformed to form a resultant thickened core portion configured to be coupled to a second electrical connection point located near the micro coaxial cable.

In some variations, a system is provided that includes a micro coaxial cable comprising a core conductive wire and a conductive shield layer, and an energy application and bonding device. The energy application and bonding device is further configured to controllably strip, through one or more applications of energy directed at the micro coaxial cable, the conductive shield layer of the micro coaxial cable to expose a portion of the core conductive wire of the micro coaxial wire, and controllably deform the exposed portion of the core conductive wire of the micro coaxial wire through the one or more applications of energy.

Embodiments of the system may include at least some of the features described in the present disclosure, including at least some of the features described above in relation to the method and to the micro coaxial cable, as well as one or more of the following features.

The energy application and bonding device may be further configured to deform a portion of the stripped conductive shield layer to form a resultant thickened shield portion, of the conductive shield layer, configured to be coupled to a first electrical connection point located near the micro coaxial cable. The energy application and bonding device configured to controllably deform the exposed portion of the core conductive wire may be configured to form a resultant thickened core portion, of the core conductive wire, configured to be coupled to a second electrical connection point located near the micro coaxial cable.

The energy application and bonding device may include an electric-flame-off (EFO) device configured to apply one or more electrical sparks to the micro coaxial cable.

The system may further include an electromagnetic-based steering mechanism to steer the one or more electrical sparks to the micro coaxial cable.

The system may further include controllably displaceable one or more electrical contacts configured to be placed at different locations on the micro coaxial cable, with the one or more electrical contacts, the micro coaxial cable, and the EFO device defining an electric path to control the one or more applications of energy directed at the micro coaxial cable.

The system may further include a feeding and cutting mechanism to dispense and cut the micro coaxial cable.

The micro coaxial cable may further include an insulating layer disposed between the core conductive wire and the conductive shield layer, with the insulating layer configured to be at least partly stripped, through the one or more applications of energy, subsequent to the stripping of the conductive shield layer. The system may further include a pressing tool configured to apply pressure to the insulating layer to push part of the core conductive wire outside the insulating layer surrounding the core conductive wire.

In some variations, an additional method is disclosed. The additional method includes controllably stripping, through one or more applications of energy directed at a micro coaxial cable, a conductive shield layer of the micro coaxial cable to expose a portion of a core conductive wire of the micro coaxial wire, and bonding a stripped portion of the stripped conductive shield layer and the exposed portion of the core conductive wire to respective electrical connection points near the micro coaxial cable.

Embodiments of the additional method may include at least some of the features described in the present disclosure, including at least some of the features described above in relation to the first method, to the micro coaxial cable, and to the system, as well as the following features.

The method may further include controllably deforming an area of the exposed portion of the core conductive wire of the micro coaxial wire through the one or more applications of energy, and bonding the deformed area of the exposed portion of the core conductive wire to one of the respective electrical connection points near the micro coaxial cable.

In some variations, an additional system is provided that includes a micro coaxial cable comprising a core conductive wire and a conductive shield layer, and further includes an energy application and bonding device. The energy application and bonding device is configured to controllably strip, through one or more applications of energy directed at the micro coaxial cable, the conductive shield layer of the micro coaxial cable to expose a portion of the core conductive wire of the micro coaxial wire, and bond a stripped portion of the stripped conductive shield layer and the exposed portion of the core conductive wire to respective electrical connection points near the micro coaxial cable.

Embodiments of the additional system may include at least some of the features described in the present disclosure, including at least some of the features described above in relation to the methods, the micro coaxial cable, and the first system, as well as the following features.

The energy application and bonding device configured to bond the stripped portion of the stripped conductive shield layer may be configured to controllably deform the stripped portion of the stripped conductive shield layer to form a resultant thickened shield portion of the conductive shield layer, and couple the resultant thickened shield portion to a first electrical connection point, from the respective electrical connection points, located near the micro coaxial cable.

The energy application and bonding device configured to bond the exposed portion of the core conductive wire may be configured to controllably deform the exposed portion of the core conductive wire to form a resultant thickened core portion of the core conductive wire, and couple the resultant thickened core portion to a second electrical connection point, from the respective electrical connection points, located near the micro coaxial cable.

Other features and advantages of the invention are apparent from the following description, and from the claims.

### DESCRIPTION OF DRAWINGS

FIGS. 1A-D are diagrams illustrating a controlled process strip and deform different wires of a coaxial cable, and/or bond the different wires to electrical connection points.

FIGS. 2A-B are diagrams illustrating an example Electric-Flame-Off (EFO) applied to an example micro coaxial cable.

FIGS. 3A-D are diagrams of an example controlled process, such as EFO, using electrical contacts (electrodes) to structurally modify a micro coaxial cable.

FIG. 4A-C are cross-sectional diagrams of example coaxial cables.

FIGS. 5A-C are diagrams showing example material arrangements for coaxial cables, and the corresponding temperatures reached by those materials after commencement of an EFO process.

FIG. 6 is a schematic diagram of an example system to cut, strip, and structurally modify a coaxial cable (at one or more points on the cable), and bond it to an electrical circuit or system.

FIGS. 7A-B are two views of an example system to feed and cut a coaxial cable.

FIG. 7C is a diagram of a system to rotate a coaxial cable, where the blades cut through the entire circumference of the cable's shield.

FIGS. 8A-F are diagrams of example pressing (crimping) tools that may be used in conjunction with the system of FIG. 6.

FIG. 9 is a flowchart of an example procedure to perform stripping and bonding operations on a micro coaxial cable.

FIG. 10 is a flowchart of another example procedure to structurally modify (through controlled stripping, deformation, and/or bonding) a micro coaxial cable.

FIG. 11 is a diagram of an example controller system.

FIGS. 12A-B are schematic views of an electromagnetic-based steering mechanism.

Like reference symbols in the various drawings indicate like elements.

### DESCRIPTION

Described herein are methods, systems, apparatus, devices, and other implementations to perform coaxial wire stripping and bonding (to electrical connection points) through one or more applications of energy. For example, the implementations described herein may be realized (e.g., to strip very fine coaxial wires, and perform further operations thereon, including bonding the stripped wires to connection points) using an electric-flame-off (EFO) process. EFO is used to create a free air ball (FAB) during a specific wire bonding process called ball bonding. The deformation (also referred to as a “ball”) is used as a bond interface and mechanical anchor in the wire bonding sequence. Current is applied to a wire for a specified amount of time to create the FAB prior to bonding. The bond between the FAB and the substrate is created when energy in the form of pressure, ultrasonic vibrations, and/or temperature is applied when the FAB comes into contact with the substrate. The current applied to the wire and the span over which that current is applied may vary, and may be controllable, depending on the materials to which the EFO process is applied and/or other factors. An advantage of the implementations described herein is that the EFO tool can be used, at least in part, to strip, deform, and bond the wires of the coaxial cable. Thus, with EFO, fewer bonding tool modifications (e.g., to existing bonding tools) are needed to wire bond coaxial cables.

In the implementations described herein, the EFO process is applied to micro coaxial cables (also referred to herein as “coaxial cables”). In a coaxial cable configuration, two conductors are present—a core and a shield. The core and the shield may be separated by a dielectric material such as a ceramic, polymer or glass. In order to access the core, a stripping method needs to be applied to the shield metal layer. In one variant, EFO induces melting and ball formation of only the shield metal. In doing so, the shield metal is stripped and deformed (e.g., balled up and retracted) from the tip of the cable, effectively stripping the cable-end and revealing the core metal (which may still be insulated). The EFO process could also be used to burn through a polymer the dielectric material or shatter a more brittle dielectric to expose the core of a coaxial wire. Layers of different metals on the core of the wire, such as a Pd coated Cu wire, could prevent the core of the wire from deformation while the EFO process is applied to the shield metal. The processes described herein may also be applied to other types of wires or cables

Thus, the implementations described herein are configured to selectively strip (e.g., melt) and deform (ball-up′) one metal (e.g., core versus shield) of a coax wire preferentially over the other. In these implementations, EFO (via one or more applications of energy, e.g., applying one or more electrical sparks) is used to strip the end of micro coaxial cable. The use of metals of dissimilar melting points in a coax wire can enhance the selectivity of the ball formation during EFO stripping. In some embodiments, a single application of energy (e.g., one spark) can initiate a process that results (due to factors such as the gradual build-up of heat in the area where the energy is applied (e.g., time-related heating of gas plasma near the coax wire), the properties/characteristics of the wire materials comprising the coax cable, and so on) in the initial stripping of the shield layer (shield wire) and the exposure of the core wire. This may be followed by the subsequent deformation of the end (tip) of the core wire. This time-based process may also include the deformation of the stripped shield layer to form a thickened layer (a ‘ball’) that can be connected to an electrical connection point. In some situations, the EFO process also include a second EFO event (e.g., a second electric spark) to ball only the insulated core metal that had been exposed from a prior process step. In such situations, the first EFO event causes the shield layer to be stripped (and/or be deformed), and the second EFO event may cause the insulated core to shatter or melt away the insulation, making it ready for bonding. In some situations, deformation of the core conductive wire may result from heat (e.g., from the gas plasma resulting from the initial, and/or subsequent, EFO event) propagating to the core wire. It is to be noted that each EFO event could include the application of several electrical sparks. For example, it could take two or more electrical sparks for the form the shield ball, and then two or more electrical sparks to form the core ball. Alternatively, both the shield and core balls could form simultaneously over two or more electrical sparks.

As will be described in greater detail below, in various implementations, a dielectric interlayer, that maintains its electrical and mechanical integrity during the EFO process, may be used. The insulator layer protects the core conductive wire and prevents/inhibit heat that is structurally modifying the shield from simultaneously also modifying the core wire (or at least limits the extent of structural modification experienced by the core conductive wire). As a result, the use of the insulator layer may allow, in some embodiments, use of materials with similar characteristics (e.g., similar melting points), or even use of the same materials, to implement the core and shield wires of the coaxial cable. Additionally, in some implementations, a cladding layer, comprising a high-melting point metal (e.g., a refractory metal such as tungsten or nickel) may be used to encapsulate and maintain the integrity of the core metal.

The implementations described herein may also include the use of a crimp or press that can modify the exposed core metal end such that core metal can be exposed past the end of the dielectric. Such implementations use a crimp-like tool configured to push the malleable metal core out of its sheath of dielectric (e.g., much the way toothpaste is squeezed out of a tube of toothpaste). The end of the core wire may be placed in a tool with sidewalls that prevent/inhibit the core metal for squeezing out laterally. A second member is then configured to press the core so as to induce transverse metal deformation extending axially and beyond the end of the insulation layer.

As will also be described in greater detail below, in some additional variations, the apparatus/systems used to perform the EFO processes described herein may include metal structures and contacts to create an electrical pathway (e.g., ending in a ground) that helps to channel most of the EFO energy (electrical current) through either the shield or core metal and reduces the amount of voltage developed across the coax dielectric. Such an apparatus/system is thus configured to place one or more electrical contacts at different locations near or along the coaxial cable to define electrical paths through which the applications of energy to the achieve the operations described herein (stripping and deforming wires, and bonding the wires to electrical connection points) are directed. Thus, in such variations, a metal electrode in the shape of, for example, a finger, fork or ring is placed adjacent to the cable end is such a way as to channel the current during EFO preferentially either in the shield or the core metal.

Accordingly, in some embodiments, a method is disclosed that includes controllably stripping, through one or more applications of energy (e.g., electrical sparks, application of laser energy bursts, etc.) directed at a micro coaxial cable, a conductive shield layer of the micro coaxial cable to expose a portion of a core conductive wire of the micro coaxial wire. The method further includes controllably deforming the exposed portion of the core conductive wire of the micro coaxial wire through the one or more applications of energy. As noted, the one or more applications of energy may include just a single application (e.g., a single electrical spark), or multiple applications of energy. Deforming the exposed portion of the core conductive wire may include forming a resultant thickened core portion of the core conductive wire (which may be shaped substantially as a ball, but may have other regular or irregular shapes, e.g., a blob) configured to be coupled to a second electrical connection point located near the micro coaxial cable. The method may also include deforming a portion of the stripped conductive shield layer to form a resultant thickened shield portion of the conductive shield layer configured to be coupled to a first electrical connection point located near the micro coaxial cable. In some embodiments, a method is provided that includes controllably stripping, through one or more applications of energy directed at a micro coaxial cable, a conductive shield layer of the micro coaxial cable to expose a portion of a core conductive wire of the micro coaxial wire, and bonding a stripped portion of the stripped conductive shield layer and the exposed portion of the core conductive wire to respective electrical connection points near the micro coaxial cable.

In some embodiments, a micro coaxial cable is provided that includes a conductive shield layer structured so that, upon one or more applications of energy directed at the micro coaxial cable, at least a portion of the conductive shield layer is stripped. The micro coaxial cable further includes a core conductive wire, disposed proximate the conductive shield layer, structured so that a portion of a region of the core conductive wire is exposed when the at least the portion of the conductive shield layer is stripped, and further structured to subsequently be deformed as a result of at least one of the one or more applications of energy directed at micro coaxial cable. The at least the portion of the conductive shield layer may be structured to be stripped upon a first application of energy directed to the micro coaxial cable, and the exposed portion of the region of the core conductive wire may be structured to be deformed upon a second application of energy directed at the micro coaxial cable. The stripped at least the portion of the conductive shield layer may further be structured to be deformed, through the one or more applications of energy, to form a resultant thickened shield portion, configured to be coupled to a first electrical connection point located near the micro coaxial cable, and the core conductive wire structured so that the exposed portion of the region of the core conductive wire is deformed as the result of the at least one of the one or more applications of energy may be structured so that the exposed portion of the region of the core conductive wire is deformed to form a resultant thickened core portion configured to be coupled to a second electrical connection point located near the micro coaxial cable. The conductive shield layer may be associated with a first melting temperature and the core conductive wire may be associated with a second melting temperature, with the first melting temperature being lower than the first melting temperature. The conductive shield layer may include a first material comprising gold, and the core conductive wire may include a second material comprising copper.

In some embodiments, a system is provided that includes a micro coaxial cable comprising a core conductive wire and a conductive shield layer, and an energy application and bonding device configured to controllably strip, through one or more applications of energy directed at the micro coaxial cable, the conductive shield layer of the micro coaxial cable to expose a portion of the core conductive wire of the micro coaxial wire, and to controllably deform the exposed portion of the core conductive wire of the micro coaxial wire through the one or more applications of energy.

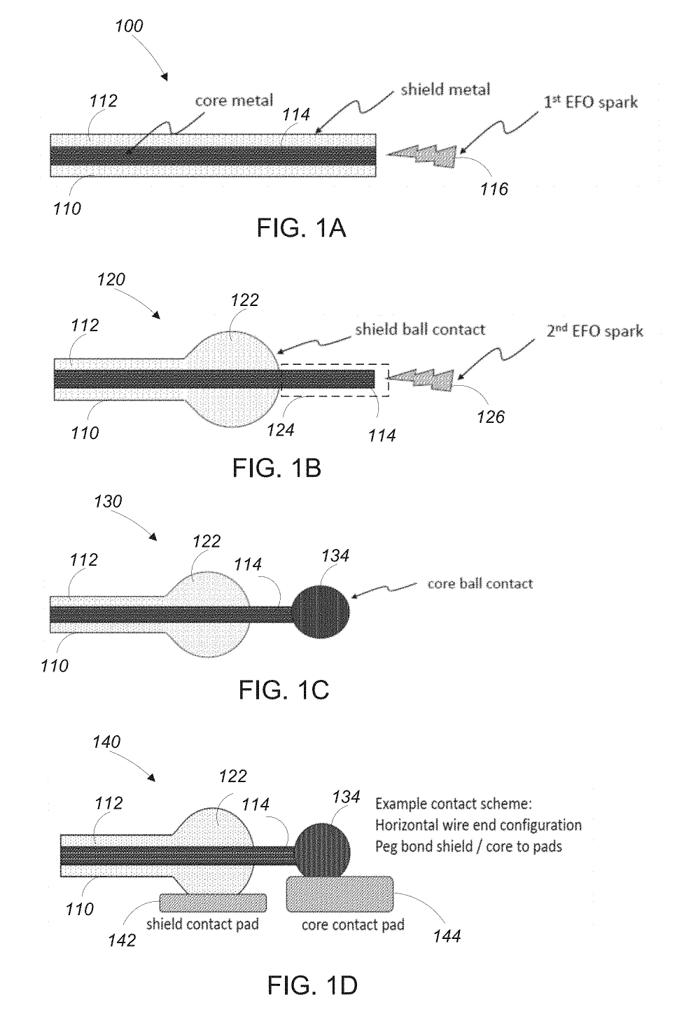

FIGS. 1A-D are diagrams illustrating the performance of a controlled process, such as an EFO process (that may include one or more EFO events), to, for example, strip and deform different wires of a coaxial cable, and/or bond the different wires to respective electrical connection points. Particularly, with reference first to FIG. 1A, a diagram 100 of a first operation performed on a micro coaxial cable 110 (illustrated in cross-section along the longitudinal axis of the cable) is shown. The micro coaxial cable comprises a conductive shield layer (also referred to as a “shield wire” or “conductive shield wire”) 112 and a core conductive wire 114 (typically surrounded by the conductive shield layer 112). In some embodiments, the conductive shield layer 112 is associated with a first melting temperature and the core conductive wire 114 is associated with a second melting temperature, with the first melting temperature being lower than the first melting temperature. In such embodiments, when the energy applied to the coaxial cable causes the temperature at or near the coaxial cable 110 to reach the first melting temperature, the conductive shield layer may be physically affected (the material will be at the melting point, and can be stripped), but the core conductive wire may remain substantially unaffected until the temperature reaches a higher level. Examples of materials that can be used for the conductive shield layer include gold. Examples of materials that can be used for the core conductive wire include copper.

As further depicted in FIG. 1A, the process (EFO process) includes controllably directing an initial application of energy, for example, the application of a first EFO (electrical spark) 116. The level of applied energy, and the duration of the application (be it the electrical spark, a burst of laser energy, or some other type of energy) can be controlled according to various factors and parameters, including one or more of, for example, the specific materials used for the micro coaxial cable 110, the proximity of the energy application device to the coaxial cable 110, the physical configuration (e.g., shape or geometry) of the cable, the use of electrical grounding contacts to define an electrical path (or a thermal path) to control the physical changes applied to the coaxial cable, the use of a steering mechanism (e.g., an electro-magnetic steering mechanism), and so on. These factors and attributes of the system can allow control (including dynamic control, based on feedback from sensors monitoring the changes to coaxial cable and/or environmental conditions) of the process to dynamically vary (and eventually cease) the application of energy.

With reference now to FIG. 1B, a diagram 120 of a process applied to the coaxial cable 110 following the application of the first of the one or more applications of energy at FIG. 1A is shown. Upon the initial application of the EFO spark (or some other energy application) the conductive shield layer is controllably stripped to expose a portion 124 of the core conductive wire 114. In some embodiments, and as depicted in FIG. 1B, the directing of the one or more applications of energy (be it the initial spark 116 and/or through subsequent applications of energy, including applying the second EFO spark 126) may also cause deformation of a portion of the stripped conductive shield layer 112 to form a resultant thickened shield portion 122 that is configured to be coupled to a first electrical connection point located near the micro coaxial cable (as is more particularly illustrated in relation to FIG. 1D). That resultant thickened shield portion 122 may have a substantially spherical (ball) shape, but, alternatively, may have any other type of shape, which may be geometrically regular or irregular shape. The initial application of energy (e.g., by applying an electric spark) may create a heat buildup in the vicinity of coaxial cable (through the presence of plasma resulting in the melting/material-stripping of the shield layer/wire), that propagates (through heat conduction) to the core conductive wire, and may initiate the structural modification of the core wire 114.

As noted, in the example illustrated in FIG. 1B, a second EFO event (i.e., the second electrical spark 126) may be controllably applied (based on attributes of the coaxial cable, the system configuration, feedback from sensor measurements, etc.) to control the level and duration of the second EFO spark 126 to continue the process of modifying the structure of the coaxial cable 110 and bond/connect it to external electrical connections. It is to be noted the first EFO spark to form the deformation 122 may comprise one or more sparks, while the second EFO spark to form the deformation 134 may also comprise one or more sparks. The second spark may affect the shape of the deformation 122 and the distance between the deformations 122 and 134.

Thus, and as illustrated in FIG. 1C, showing a diagram 130 of the coaxial cable subsequent to the exposure of the portion 124 of the core conductive wire, as a result of the one or more applications of energy (be it a single application of energy, or multiple applications) the exposed portion of the core conductive wire is controllably deformed. For example, the deformation of the exposed portion of the core conductive wire forms a resultant thickened core portion 134 of the core conductive wire configured to be coupled to a second electrical connection point located near the micro coaxial cable. While in FIG. 1C the deformation 134 is depicted as a circular (spherical or ball-shaped) deformation, the deformation may be of any shape, including geometrically regular or irregular shapes.

Following the deformation of at least one of the exposed portion of the core conductive wire and/or the conductive shield layer, the resultant deformation 122 and/or the deformation 134 may be bonded to electrical contacts 142 and 144 as depicted in FIG. 1D (showing a diagram 140 of the coaxial cable 110). The bonding may be achieved by simply bringing in contact the still heated deformations 122 and 134 with the electrical contacts 142 and 144, and/or applying further operations to secure and bond the deformations to the contacts. However, in some embodiments, the deformations (balls) do not need to be heated in order to make a metallic bond to the contact points 142 and 144. Rather, the bonds may be made at room temperature or at elevated temperature. In some variations, the bonding process may also be implemented to include one or more of diffusion bonding the electrically conductive portions (of the shield layer or core wire, whether or not either or both of them have been deformed) to the respective electrical connection points, brazing the electrically conductive portions of the coaxial cable to the respective electrical connection points, sintering bonding the electrically conductive portions of the coaxial cable to the respective electrical connection points, or attaching the conductive portions to the respective electrical connection points using conductive adhesives. In some embodiments, the bonding process may also include welding (e.g., through thermosonic welding, laser welding, etc.) the electrically conductive portions of the coaxial cable to the respective electrical connection points, thermo-compression bonding the conductive portions to the electrical connection points, ultrasonically bonding the electrically conductive portions to the respective electrical connection points, etc. Thus, in some embodiments, the process, as illustrated in FIGS. 1A-D, includes coupling (connecting or bonding) the resultant thickened shield portion of the conductive shield layer to the first electrical connection point located near the micro coaxial cable, and coupling the resultant thickened core portion of the core conductive wire to the second electrical connection point located near the micro coaxial cable. In some embodiments, one of the electrical connection points may include a ground connection point.

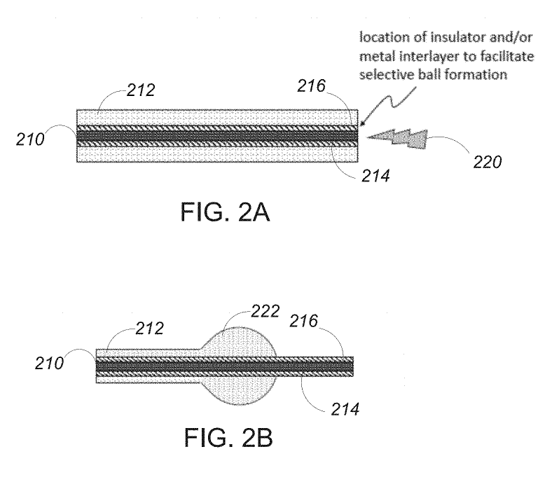

FIGS. 2A-B are diagrams illustrating another example EFO process, similar to the process described in relation to FIGS. 1A-D, applied to another example micro coaxial cable 210. FIG. 2A shows, in cross-section, the micro coaxial cable 210 which includes a shield conducting wire 212 (which may be similar to the conductive shield layer 112 of FIGS. 1A-D), surrounding a core conductive wire 214 (which may be similar to the core conductive wire 114 of FIGS. 1A-D). As shown in FIGS. 2A-B, the coaxial cable 210 further includes an insulating layer 216 disposed between the core conductive wire and the conductive shield layer. The insulating layer may include one of, for example, a polyimide layer surrounding the core conductive wire, and/or a polyurethane layer surrounding the core conductive wire. The insulating layer 216 may be configured to remain substantially intact when the one or more applications of energy causes the stripping of the conductive shield layer. Thus, after the application of an EFO spark 220 (as depicted in FIG. 2A), the conductive shield layer 212 is stripped and deformed to form a thickened layer 222 (a ‘ball’, illustrated in FIG. 2B). However, the application of the EFO spark 220 does not cause the insulating layer 216, or the core conductive wire 214 surrounded by the insulating layer 216, to be stripped or deformed.

In some variations, the insulating layer may also be configured to be at least partly stripped, through the one or more applications of energy, subsequent to the stripping of the conductive shield layer so as to expose an uninsulated portion of the core conductive wire. The partial stripping of the insulating layer may be achieved using a crimping tool (as will be described in greater detail below) that presses on a portion of the insulating layer to squeeze out and expose at least a portion of the core conducting wire. In some variations, the stripping of the insulating layer may be caused through the EFO process applied to the coaxial cable (the one or more applications of energy). Particularly, the insulating layer 216 may be structured using materials whose melting temperature is higher than that of the shield conducting wire 212, but lower than that of the core conducting wire 214.

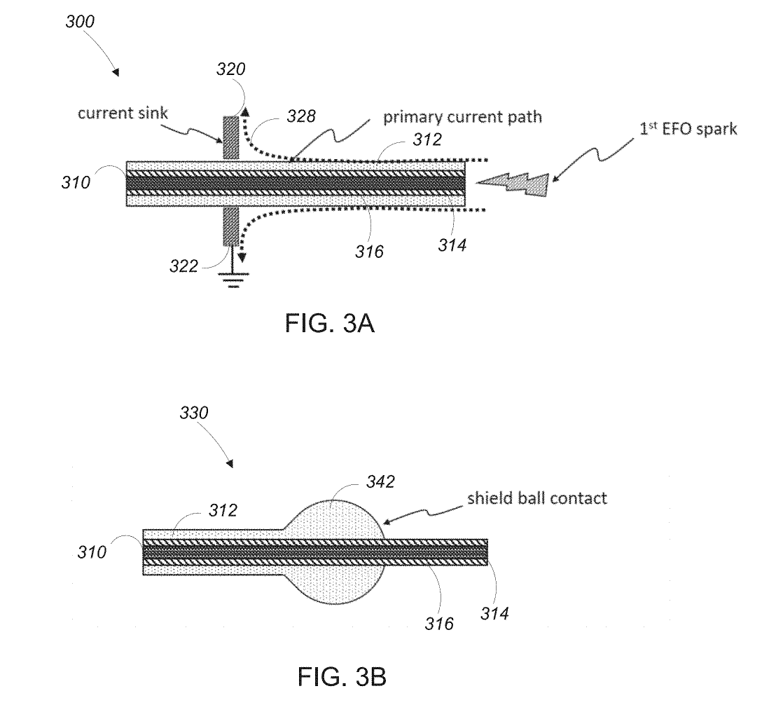

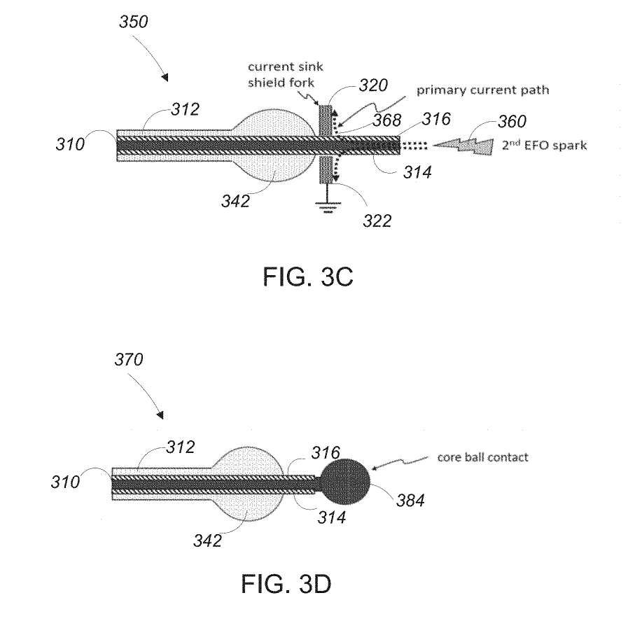

To further facilitate the performance of the processes and methods described herein, e.g., structurally modifying a micro coaxial cable via an EFO process to facilitate bonding between conductive portions of the cable and electrical connection points, one or more electrical contacts may be used to define a path from an energy application tool through one or more of the wires of the micro coaxial cable. More particularly, with reference to FIG. 3A, a diagram 300 of an example system that includes a coaxial cable 310 that is configured to be structurally modified by, for example, an EFO process, is shown. The coaxial cable 310 may be similar, in configuration and/or materials used, to the micro coaxial cable 210 depicted in FIGS. 2A-B, and may include a core conductive wire 314 surrounded by an insulating layer 316, which itself is surrounded by a conductive shield layer 312. As shown in FIG. 3A, two electrical contacts 320 and 322 are coupled to the coaxial cable 310 at locations on the conductive shield layer 312 that are near the area where the deformation at the conductive shield layer 312 is to occur. Thus, the placement of the electrical contacts 320 and 322 define electrical paths from the energy application tool (not shown in FIG. 3A) via the conductive shield layer 312, and to the electrical contacts 320 and 322. The application of energy (e.g., an EFO spark) along the defined paths (for example, along a path 328) causes the application of the energy at locations on the conductive shield layer 312 corresponding to that path. Consequently, the locations on the shield layer corresponding to the electrical path will undergo a controlled stripping and/or deformation resulting from the one or more applications of energy along the defined path.

FIG. 3B is a diagram 330 showing the coaxial cable 310 after its modification through the EFO process illustrated in FIG. 3A. As shown, after directing the one or more applications of energy (in this case the EFO spark provided in FIG. 3A) via the electrical paths that were defined by the one or more electrical contacts 320 and 322, a deformation 342 of the stripped end of the conductive wire 312 is formed. The deformation is ball-shaped, but other shapes may result from the EFO process implemented in FIG. 3A. In the example of FIGS. 3A and 3B, the application of the first EFO spark does not structurally deform the other layers of the coaxial cable 310, but it does leave a portion of the insulating layer 316 and a portion of the core conductive wire 314 exposed (i.e., not covered by the portion of conductive shield layer 312 that was stripped).

Subsequent to forming the deformation 342, the one or more electrodes 320 and 322 may be moved (retracted or displaced), and the same, or different, electrodes may be positioned at locations on the now exposed portions of the insulation layer 316 and the core conductive wire 314 to define new energy (electrical) paths through which energy may be applied to the exposed insulating layer and the exposed portion of the core conductive wire. Accordingly, and with reference to FIG. 3C, a diagram 350 is provided showing further operations performed on the modified coaxial cable 310 after the deformation 342 is formed. In FIG. 3C, a second EFO spark 360 is applied to the coaxial cable (structurally modified, as shown in FIGS. 3A-B, by application of the first EFO spark). As noted, in some embodiments, the further modification of the coaxial cable may be performed without needing to further apply energy (e.g., the EFO process may continue as a result of the buildup of heat, and its propagation within the coaxial cable via thermal conduction, resulting from the initial EFO spark). In FIG. 3C, the electrical contacts 320 and 322 have been displaced (e.g., manually, or automatically by a system) to locations on the exposed insulating layer. In some embodiments, the electrical contacts used in the operations of FIG. 3C may be different from those used in the operations of FIG. 3A. The placement of the electrical contacts 320 and 322 at the locations on the insulating layer 316 defines the new electrical paths (such as a path 368), and upon application of the second electrical spark, the electrical energy passes via the exposed insulating layer and/or the exposed portion of the core conductive wire, to the electrical contacts 320 and 322.

FIG. 3D is a diagram 370 showing the resultant modified coaxial cable 310 following the application of energy via the placement of electrical contacts at the insulating layer 316. As a result of the application of energy, the exposed portion of the insulating layer 316 and/or the exposed portion of the core conductive wire 314 undergo structural modification to strip at least some of the exposed portion of the insulating layer 316, and to deform at least part of the exposed portion of the core conductive wire. The core conductive wire is deformed into a thickened layer (e.g., which may be shaped as a sphere or ball) 384. The deformations 342 and 384 may be bonded/coupled to electrical connection points (not shown in FIG. 3D) in a manner that may be similar to that described in relation to FIG. 1D.

Thus, in the processes described herein, controllably stripping the conductive shield layer may include placing one or more electrical contacts at a first location proximate the conductive shield layer, and directing a first electrical current via a first path defined, in part, by the conductive shield layer and the one or more electrical contacts placed at the first location proximate the conductive shield layer. In such processes, controllably deforming the core conductive wire may include placing at least one electrical contact at a second location proximate the core conductive wire, and directing a second electrical current via a second path defined, in part, by the core conductive wire and the at least one electrical contact placed at the second location proximate the core conductive wire.

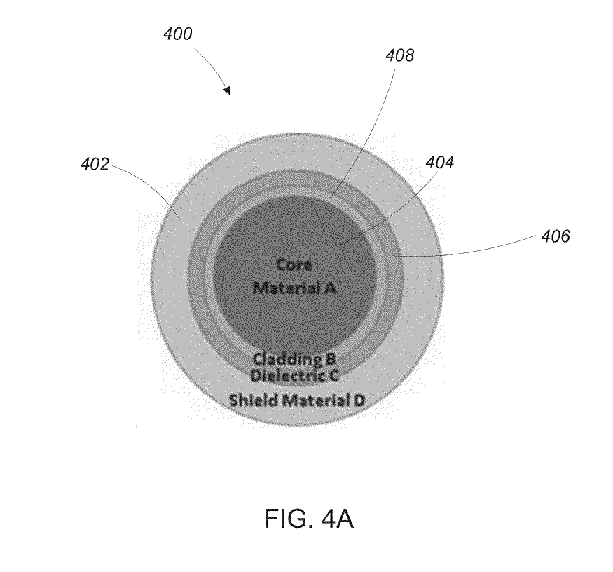

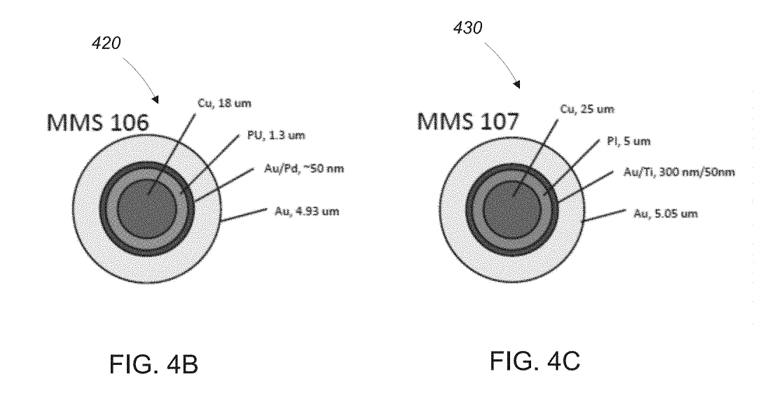

With reference next to FIG. 4A, a cross-sectional diagram of another example coaxial cable 400 is shown. The example coaxial cable 400 includes a core conductive wire 404, which may be similar to the core conductive wires 114, 214, or 314, of FIGS. 1A-D, 2A-B, or 3A-D, and is surrounded by a dielectric (insulating) layer 406 (which may be similar to the insulating layer 216 of FIGS. 2A-B). Surrounding the dielectric layer 406 is a conductive shield layer 402, which may be similar to the conductive shield layer 112, 212, or 312 of FIGS. 1A-D, 2A-B, or 3A-D, and as such may be structured so that, upon one or more applications of energy directed at the micro coaxial cable, at least a portion of the conductive shield layer 402 is stripped. As noted, the insulating layer, such as the insulating layer 406 may be structured to be at least partly stripped, through the one or more applications of energy (whether there is single energy burst causing a buildup of heat, and increasing temperature, that results in a staggered structural modification of the different materials of the coaxial cable, or through multiple bursts which cause the structural modifications), subsequent to the stripping of the conductive shield layer so as to expose an uninsulated portion of the core conductive wire. As with the insulating layer 216 shown in FIG. 2A-B, the insulating layer 406 of FIG. 4 may include one of different insulation materials, including polymers, such as polyimide or polyurethane, or inorganic oxides, such as silicon oxide, or other types of insulators.

As further shown in FIG. 4A, in some embodiments, the coaxial wire may further include a cladding layer 408 (denoted as “Cladding B”) disposed between the core conductive wire and the conductive shield layer (and, more particularly, between the core conductive wire 404 and the insulating layer 406 in embodiments that include the insulating layer 406), with the cladding layer 408 configured to remain substantially intact in response to the one or more applications of energy to the micro coaxial cable, with at least a portion of the cladding layer configured to break upon deformation of the exposed portion of the core conductive wire of the micro coaxial cable. The purpose of the cladding material on the core is to separate the conditions that cause shield ball formation from the conditions that allow the core to ball. This might be because of the physical or geometric constraints of the cladding material. For example, if it does not melt (because its melting temperature is higher than the shield ball temperature), it constrains the core's ability to deform (ball). Alternatively, this might be because the cladding material does not allow sufficient transfer of energy from the shield to the core, or from the spark to the core. For example, the cladding could have a high resistance, limiting electrical current to the core, or it could have a low thermal conductance, limiting heat transfer to the core. It is to be noted that what matters here is resistance, not solely the material's resistivity. A thick cladding of moderate resistivity material may have a greater effect than a thin cladding of high resistivity material.

In constructing the cladding layer 408, the following material considerations may be made. The cladding layer 408 could have a higher resistivity (but does not have to) than the core conductive wire 404 or the conductive shield layer 402 to maintain EFO current density in the core and conductive shield layers, respectively. An example of a material with such a property is Nickel (Ni), which can thus be used in a coaxial cable arrangement comprising Cu/Ni/Au (i.e., a copper core, surrounded by a nickel cladding layer, surrounded by a gold shield layer). The cladding layer 408 could also have (but does not have to) a higher melting temperature than the core and conductive shield layers. Here too, nickel has this material characteristic, with a melting temperature of approximately 1400° C., and is therefore a suitable material for a core/cladding/shield arrangement (e.g., Cu/Ni/Au). A higher resistivity of the cladding might play a role in selectively balling the core or the shield. One of the motivations for selecting Ni is that the thermal conductivity is much lower than Cu. If the shield 402 is grounded, then the EFO spark with ground itself on the shield. Deformations in the core 404 from the first spark will happen if any material in contact with the core is at a higher temperature than the melting point of the core material. The cladding may act as a thermal insulator. The cladding can be located adjacent to the core, as shown in FIG. 4A, or at the exterior of the dielectric layer. A drawback to having a cladding of any significant thickness directly on the core is that it may limit the electrical performance of the coax at high frequency (due to the skin effect).

In some embodiments, the cladding layer 408 or the insulating layer (dielectric) may be brittle to allow the cladding layer to break off during the EFO. An example material with that characteristic is SiO2 (which is an insulator that also serves as a cladding later), resulting in an arrangement of Cu/SiO2/Au. In other cases, for example if the dielectric has a low melting or decomposition temperature such as polyurethane, an additional cladding layer may be necessary. In some implementations, another material that may be used for the cladding layer is Tungsten, which is an extreme example of the properties above (Ni being a more gentle example).

Processing consideration that may be made to construct the coaxial cable described herein include electroplating or electroless-plating the cladding layer 408 to the core conductive wire 404. In some embodiments, the cladding layer 408 may be chosen so that it forms a core-cladding intermetallic arrangement during the EFO process (i.e., the EFO applied to the coaxial cable results in the formation of a core-cladding intermetallic, surrounding the core conductive wire 404). Intermetallics can form in <1 ms at typical EFO temperatures, and typically have a higher melting temperature, a higher resistivity, and are more brittle than the constituent materials of the core-cladding arrangement. Examples material that may be used include, for example, Au—Al intermetallic. In some embodiments, a cladding layer material may be chosen that oxidizes during EFO. An example could be Al.

Thus, in some embodiments, the methods, procedures, and other implementations described herein may include forming a cladding layer through the one or more applications of energy that causes a chemical reaction of a cladding material with other materials at or near the micro coaxial cable. The cladding material can therefore undergo a reaction during the EFO process to form the functional cladding layer. For example, an Al cladding material could be used to form an Al₂O₃ cladding layer during EFO (e.g., through reaction with ambient oxygen), or such an Al cladding material could be used to form an Al—Au intermetallic cladding layer during EFO (with Au in the core or shield). Other types of cladding materials could be used.

FIGS. 4B-C include alternative example coaxial cable configurations, including the materials and dimensions, for coaxial cables 420 and 430. The coaxial cables 420 and 430 are arranged with a central core conductive wire, surrounded by a dielectric (insulator), a cladding layer (and/or a seed or adhesion layer that is used to promote adhesion of the shield to the dielectric to facilitate deposition of the shield), and a shield conductive layer. The cladding layer may be disposed either between the core and dielectric layers, or between the dielectric and shield layers.

Particularly, the coaxial cable 420 includes a copper core (18 μm), surrounded by a polyurethane (PU) layer (1.3 μm), surrounded by an Au/Pd cladding layer (50 nm), which is surrounded by an Au conductive shield layer (4.93 μm). The coaxial cable 430, on the other hand, includes a copper core conductive wire (25 μm), surrounded by a polyimide (PI) layer (5 μm), surrounded by an Au/Ti seed/adhesion layer (300 nm/50 nm), which is surrounded by an Au conductive shield layer (5.05 μm).

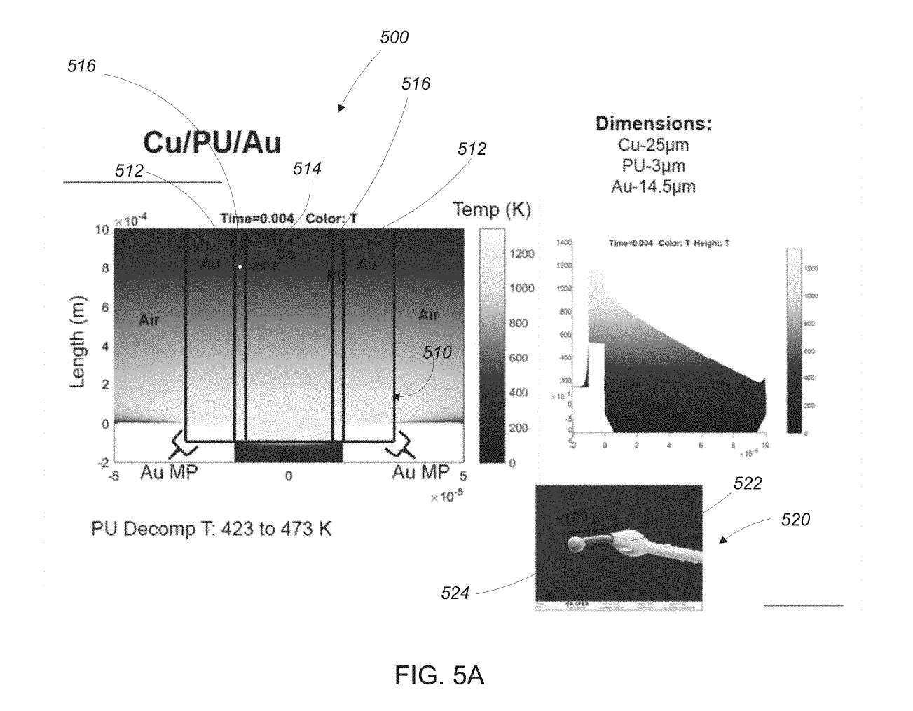

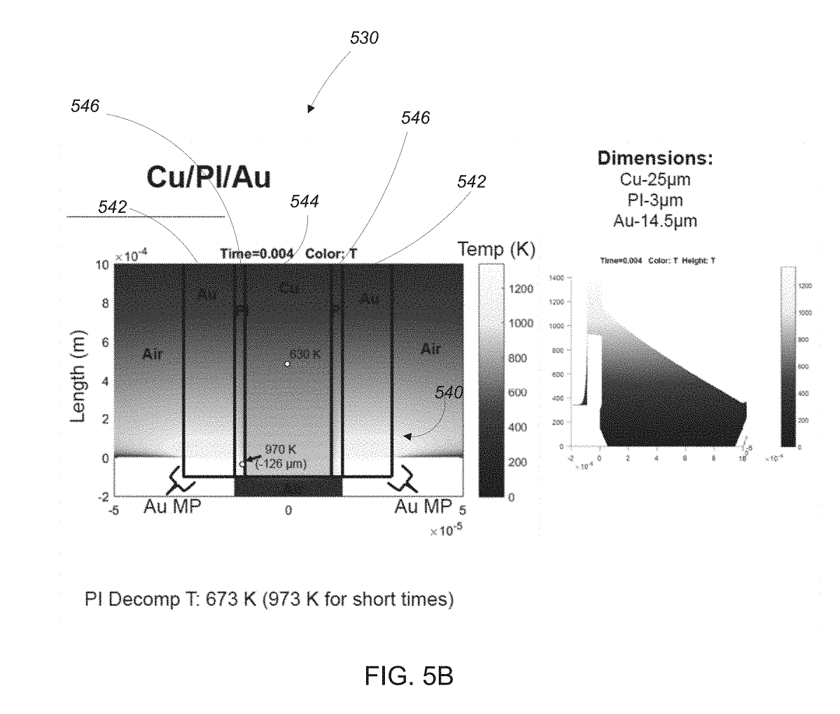

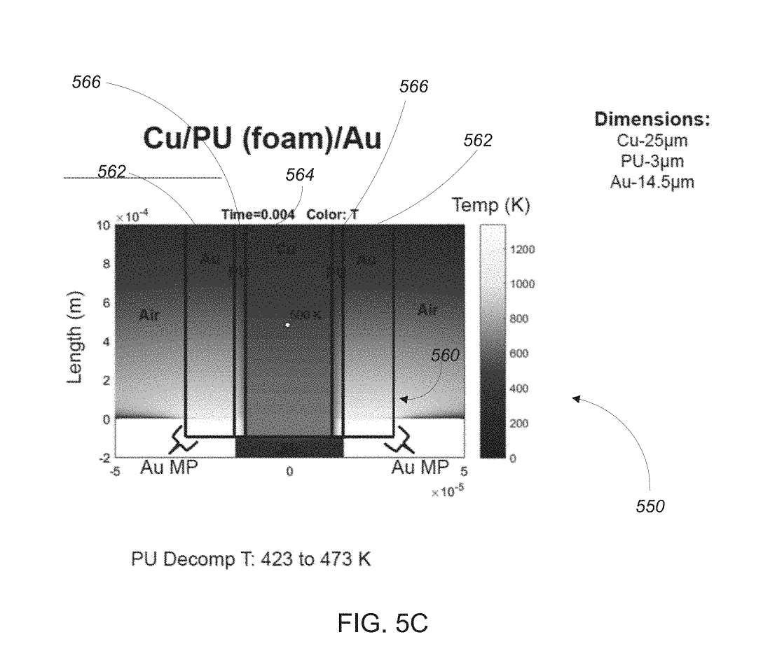

With reference next to FIGS. 5A-C, diagrams showing example material arrangements for coaxial cables, and example temperatures reached by those materials shortly after commencement of an EFO process, are provided. In a first example, FIG. 5A includes a diagram 500 showing an example coaxial cable arrangement 510 that includes a copper-based (Cu) core wire 514, a polyurethane (PU) insulating layer 516, and a gold-based (Au) shield layer 512. The dimensions of the different materials in this example arrangement are 25 μm, 3 μm, and 14.5 μm for the copper wire, polyurethane layer, and gold wire, respectively. As with the other example coaxial cables described herein, the conductive shield layer is structured so that, upon one or more applications of energy directed at the coaxial cable, at least a portion of the conductive shield layer is stripped, and the core conductive wire, disposed proximate the conductive shield layer, is structured so that a portion of a region of the core conductive wire is exposed when the at least the portion of the conductive shield layer is stripped, and subsequently is deformed as a result of at least one of the one or more applications of energy directed at the coaxial cable.

In the diagram 500, the shades at different points of the coaxial cable 510 represent the temperatures at those locations shortly after the commencement of the EFO process, with lighter shades indicating higher temperature, and darker shades indicating darker lower temperature. Thus, as illustrated, at the 0.004 s point, the temperatures at the conductive shield layer (at different distance points from the point at which the EFO energy is applied) are relatively close to the temperature at the insulating layer 516 and the core conductive wire 514 at similar distances (from the point of EFO energy application). As shown in the photograph 520 (inset), the EFO process applied to the example coaxial cable 510 results in the stripping of the conductive shield layer to a distance approximately 100 μm from the tip of the coaxial cable (proximate to where the EFO energy is applied), the deforming of a portion the conductive shield layer (to form the deformation 522), and the deforming of the exposed core conductive wire (to form the deformation 524).

FIG. 5B includes a diagram 530 of another example coaxial cable 540 with another example arrangement of materials. Particularly, the coaxial cable 540 includes a copper-based (Cu) core conductive wire 544, surrounded by a polyimide (PI) insulating layer 546, and a gold-based (Au) conductive shield layer 542. As illustrated in FIG. 5B, in this arrangement the selection of materials results in greater temperature differentials between the conductive shield layer 542, and the insulating layer 546 and the core conductive wire 544, with the temperatures at locations on the conductive shield layer 542 at various distances (from the tip of the coaxial cable) being larger (hotter) than at the corresponding locations at the insulating layer and core wire at the same respective distances. This selection of materials (the dimensions of the different wires and layers are the same as those used for the cable 510 of FIG. 5A) can result in different temperature characteristics upon EFO energy application, thus resulting in different timing characteristic and/or structural modification characteristics for the coaxial cable. For example, due to the more insular characteristics of the insulating layer and the core wire, the stripping and deformation process can be separated to occur over a longer sequence of time, which may allow the structural modification and bonding processes to be more carefully regulated.

FIG. 5C includes a diagram 550 of another example coaxial cable 560 with another example arrangement of materials. In this example, the coaxial cable 560 includes a copper-based (Cu) core conductive wire 564, surrounded by a polyurethane (PU) insulating foam layer 566, and a gold-based (Au) shield layer 562. The use of a foam-based polyurethane insulating layer may result in a greater temperature differential between the conductive shield layer 562, and the insulating foam layer 566 and the core conductive wire 564, with the temperatures at locations on the conductive shield layer 562 at various distances (from the tip of the coaxial cable) being larger (hotter) than at the corresponding locations at the insulating layer and core wire at the same respective distances. This particular selection of materials (the dimensions of the different wires and layers are the same as those used for the coaxial cable 510 of FIG. 5A or the coaxial cable 540 of FIG. 5B) offer another measure of control over the processes described herein (to structurally modify the coaxial cables). The material characteristics used for the coaxial cable 560 can therefore provide different timing profiling for structurally modifying the different materials comprising the coaxial cable 560.

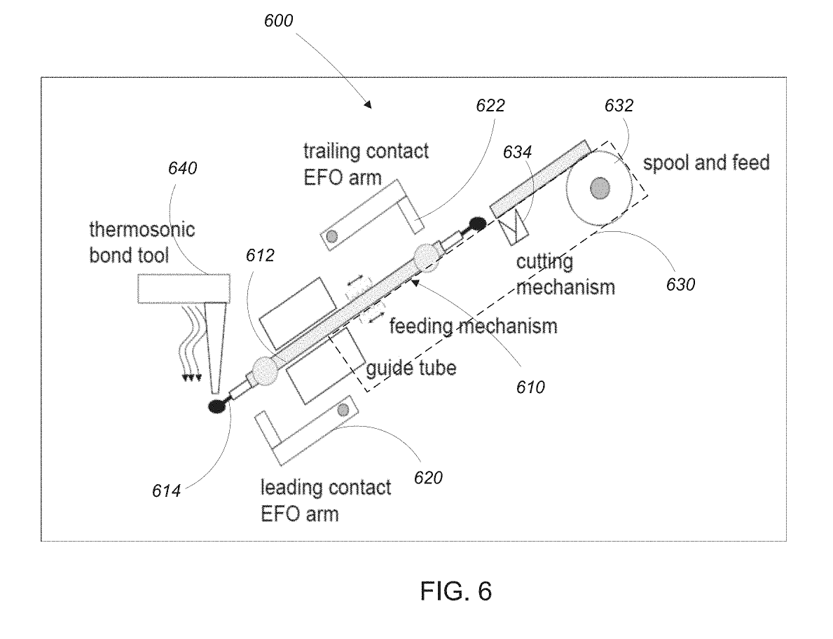

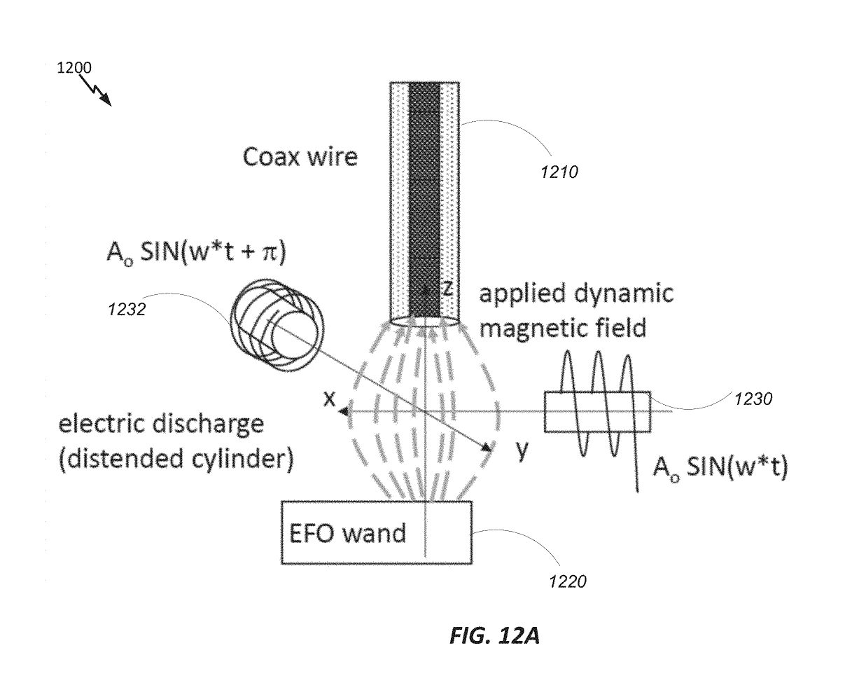

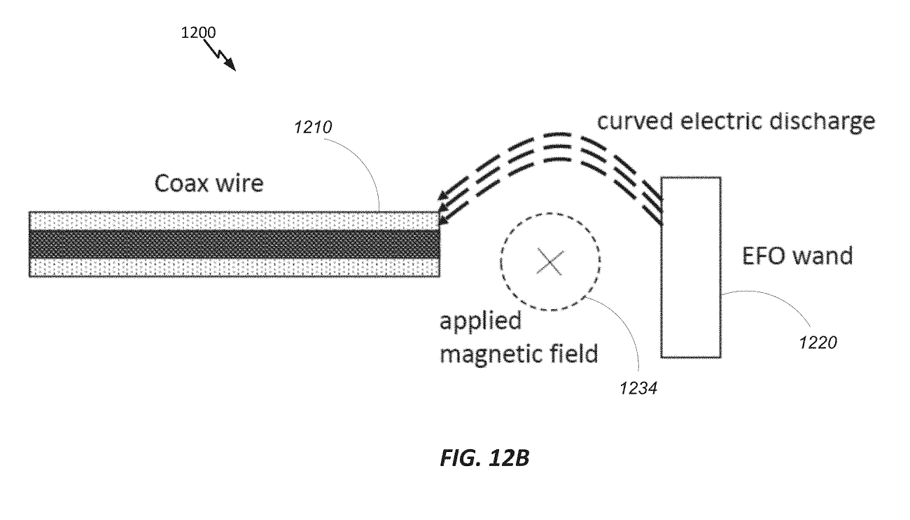

The coaxial cable configurations described herein can be used to controllably structurally modify through one or more applications of energy (realized via an EFO process) a coaxial cable, to strip and deform end sections of the coaxial cable to thus facilitate the bonding of the structurally modified coaxial cable to electrical connection points (e.g., on a printed circuit board, or on some other electrical circuit configuration). Accordingly, with reference next to FIG. 6, a schematic diagram of a system 600 to structurally modify a coaxial cable (a micro coaxial cable) and bond it to an electrical circuit is shown. The system 600 includes energy applicators 620 and 622, which, in the embodiment of FIG. 6 are EFO contact arms configured to apply electrical sparks (or other types of energy applications) to ends of a coaxial cable section 610. In some implementations, the electrical sparks may be guided to the coaxial cable 610 using an electromagnetic-based steering mechanism. For example, with reference to FIG. 12A, a schematic diagram of an electromagnetic-based steering mechanism 1200 that includes two electromagnets 1230 and 1232, used to steer electrical sparks generated by an EFO wand 1220 (which may be similar to either of the EFO contact arms 620 and 622 of FIG. 6) applied to a coaxial cable 1210 (which may be similar to the cable 610 of FIG. 6), is shown. As illustrated in the example of FIG. 12A, two orthogonal electromagnets driven sinusoidally with a 180 degree phase offset, and with periodicity shorter than the duration of the arch discharge, can be used to circumscribe the discharge around the axis of the coax wire 1210. FIG. 12B is another view of the mechanism 1200 in which the resultant electromagnetic field applied to the spark is illustrated. As shown, a magnetic field 1234, which may either be static or dynamic, can be used to shape and direct the energy of the EFO discharge toward the shield metal of the coaxial cable 1210. By directing the discharge in a curve, the plasma impinges on the wire from and off-axis direction, to thus increase the temperature of the shield metal relative to the core metal. This can make the process more selective in forming a deformation (‘ball’) from the shield layer versus the core wire.

Turning back to FIG. 6, the coaxial cable 610 may be similar to any of the coaxial cable described in relation to FIGS. 1A-D, 2A-B, 3A-D, 4A-C, and/or 5A-C. As such, the coaxial cable 610 may include, for example, a conductive shield layer 612 structured so that, upon one or more applications of energy directed at the coaxial cable, at least a portion of the conductive shield layer is stripped, and a core conductive wire 614, disposed proximate the conductive shield layer, structured so that a portion of a region of the core conductive wire is exposed when the at least the portion of the conductive shield layer is stripped, and is subsequently deformed (e.g., into a deformation 615) as a result of at least one of the one or more applications of energy directed at the micro coaxial cable.

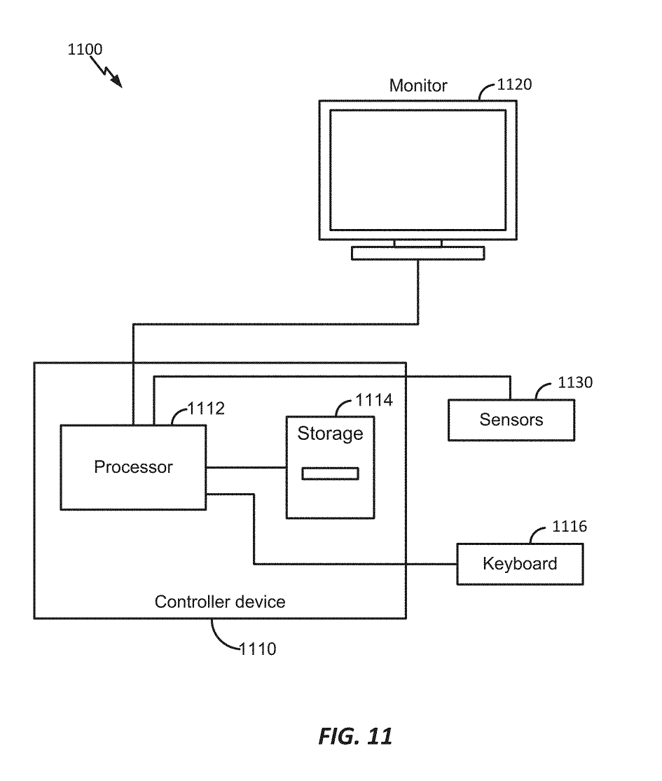

When the energy applicator, e.g., the EFO contact arm 620 (also referred to as an EFO wand), is activated, a large voltage is applied between the end of the coaxial cable 610 and the EFO contact arm 620, which results in a spark. A controller (not shown) to control the EFO contact arm 620, and/or the other modules/components of the system 600, may regulate the voltage level and application duration to achieve the shield layer stripping and deformation of the core wire and/or shield layer. The controller may be configured to apply the voltage based on pre-determined characteristics of the coaxial cable, the system, and the environments, as well as based on measurements taken by various sensors used by, or in communication with, the controller (FIG. 11 is a schematic diagram of an example controller). For example, the controller may regulate the application of energy (e.g., maintain the voltage applied to the EFO contact arm 620 and/or the contact arm 622) based on temperature measured by one or more thermometers (e.g., to reduce the application of voltage if temperature is too high). Other sensor measurements that may be used to control the energy application process may include pressure sensors, visual/optical sensors (e.g., image the coaxial cable to determine extent of stripping and deformation), and so on. Additionally, the extent of energy application (regulated by the controller) may also be based on pre-determined characteristics of the system, including the types of energy applicators used, the materials comprising the coaxial cable 610, location of the EFO contact arm (relative to the coaxial cable), power and duration characteristics of the one or more applications of energy, whether (and what type) gas material is used to generate heat in the vicinity of the micro coaxial cable (i.e., in some embodiment, the system 600 may also be configured disperse flammable gas that can ignite to facilitate the stripping and deformation operations described herein), geometry of the coaxial cable, and/or locations of grounding points to define one or more energy paths for the one or more applications of energy (as described in relation to FIGS. 3A-D).

As noted, multiple EFO contact arms may be used that can operate substantially simultaneously with, and independently of, each other. Thus, for example, in the embodiments of FIG. 6, the second EFO contact arm 622 may be positioned to apply energy to the other end of the section of the coaxial cable 610. The EFO contact arm 622 (or some other type of energy applicator) may also be controlled, to regulate the level and duration of energy applied (and/or the proximity of the applicator to the location on the coaxial cable 610 to which the energy is to be directed) based on factors similar to those described in relation to the EFO contact arm 620, including characteristics of the various materials used (of the coaxial cable), the geometry of the coaxial cable, whether a heating gas is used, measurements from various sensors received by a controller to control the EFO contact arm 622 (which may be the same or different from the controller used to control the EFO contact arm 620), etc. In some embodiments, additional energy applicators may be employed to simultaneously operate (e.g., perform EFO processes) on additional cable/wire sections.

In some implementations, the system 600 may further include controllably displaceable one or more electrical contacts (such as the electrodes 320 and 322 of FIG. 3A) configured to be placed at different locations on the coaxial cable 610, with the one or more electrical contacts, the coaxial cable, and the EFO contact arm (device) associated with the one or more electrical contacts defining an electric path to control the one or more applications of energy directed at the coaxial cable. The electrical contacts may be part of the respective EFO contact arm (620 or 622), or may be part of a separate module/unit of the system 600, separate from the EFO devices (the EFO contact arms).

As further illustrated in FIG. 6, in embodiments in which multiple EFO contact arms are used to operate on opposing ends of a cable section, the coaxial cable needs to be cut from a cable feed to provide a separated cable section. Accordingly, in such embodiments, the system 600 may further include a feeding and cutting mechanism 630 to dispense and cut the micro coaxial cable. The feeding and cutting mechanism 630 includes a feeding device (which includes a spool-based device 632) to provide a continuous feed of the micro coaxial cable 610, and a cutting tool 634 (e.g., a scissor-like tool, a disc-shaped cutting blade that can controllably cut the coaxial cable to a specified depth, etc.)

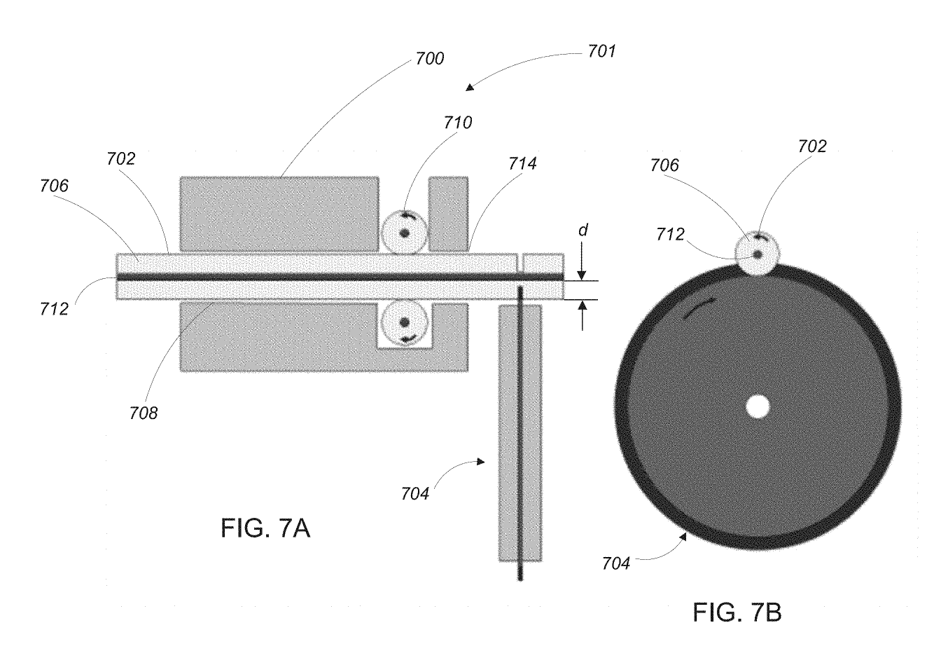

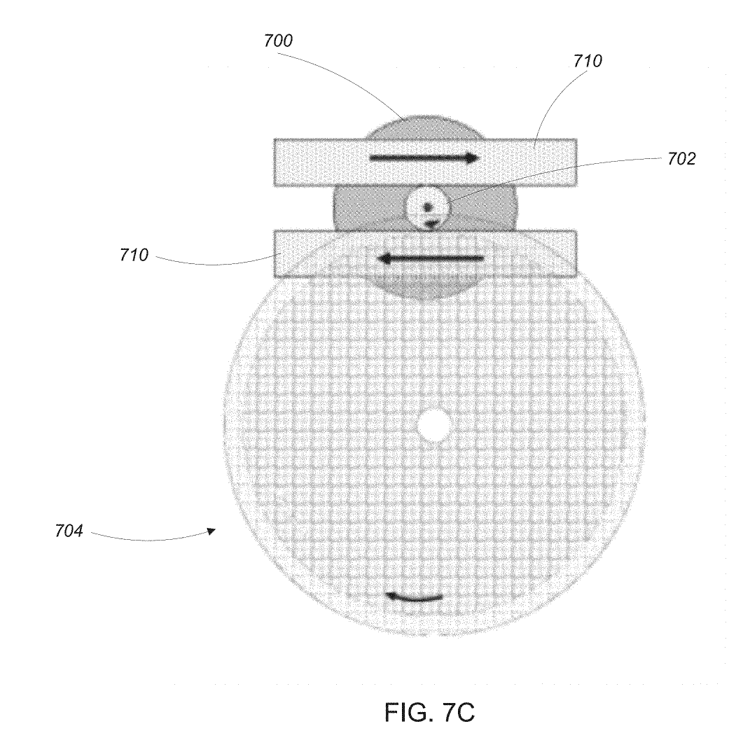

Another example feeding and cutting mechanism implementation, which may be used in place of the mechanism 630, is illustrated in FIGS. 7A and B. In that example, an apparatus 701 for feeding and layer removal of coaxial wires includes a tubular feed mechanism 700 for feeding and rotating a coaxial wire 702 (which may be similar to the coaxial cables described herein) and a spinning cutting blade 704 for cutting through the entirety of the coaxial cable or through one or more layers of the coaxial wire (e.g., in embodiments in which at least part of the wire stripping functionality is performed independently of the EFO process). In such embodiments, the spinning cutting blade 704 may be disposed adjacent to and just outside an opening 714 of the tube 708, and may be configured to make an incision about the entire circumference of the coaxial wire 702 to a predetermined depth, d as the wire 702 rotates about its core 712. In embodiments in which wire stripping functionality is achieved via an EFO process (as described herein), cutting or severing the coaxial cable (to separate a cable section from the cable bulk rolled on the spool) can be achieved through cutting blades (scissor or shear-like).

The tubular feed mechanism 700 includes a tube 708 and more or more rotating shafts 710 disposed adjacent to the tube 708 for engaging an outer surface of the coaxial cable 702. The rotation of the shafts 710 feeds (i.e., pushes or pulls) the coaxial cable 702 through the tube 708. In some example variations, the shafts 710 may also be configured to move linearly along their own axes see (e.g., FIG. 7C), causing rotation of the coaxial wire about its core 712. In general, the shafts 710 may be capable of rotating the cable at least 360 degrees about its core 712. Thus, in some embodiments, the feeding and cutting mechanism 630 is configured to rotate the coaxial wire during cutting and to simultaneously spin a cutting wheel. Additional details regarding examples of feeding, cutting, and bonding mechanisms are provided in U.S. patent application Ser. No. 15/592,694, entitled “Wiring System,” the content of which is hereby incorporated by reference in its entirety.

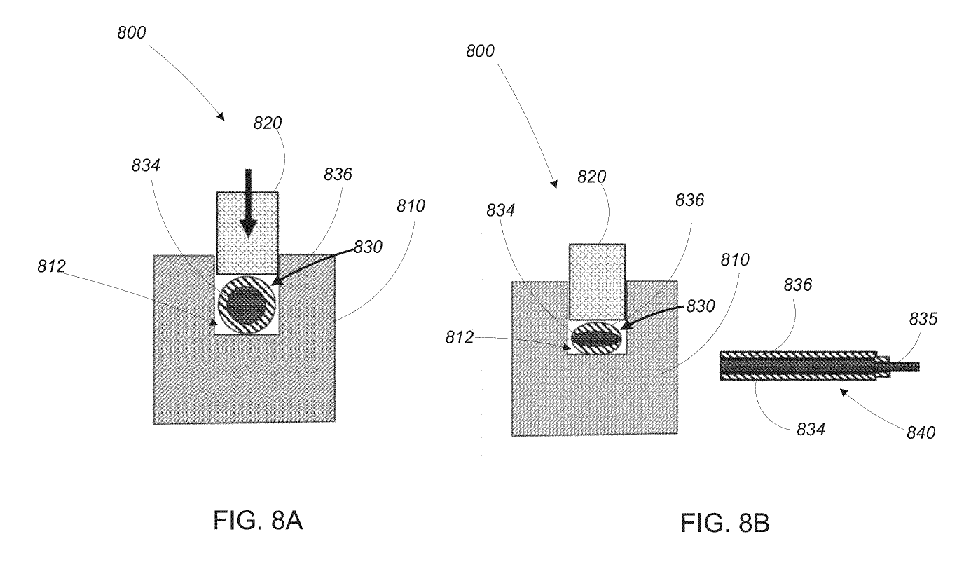

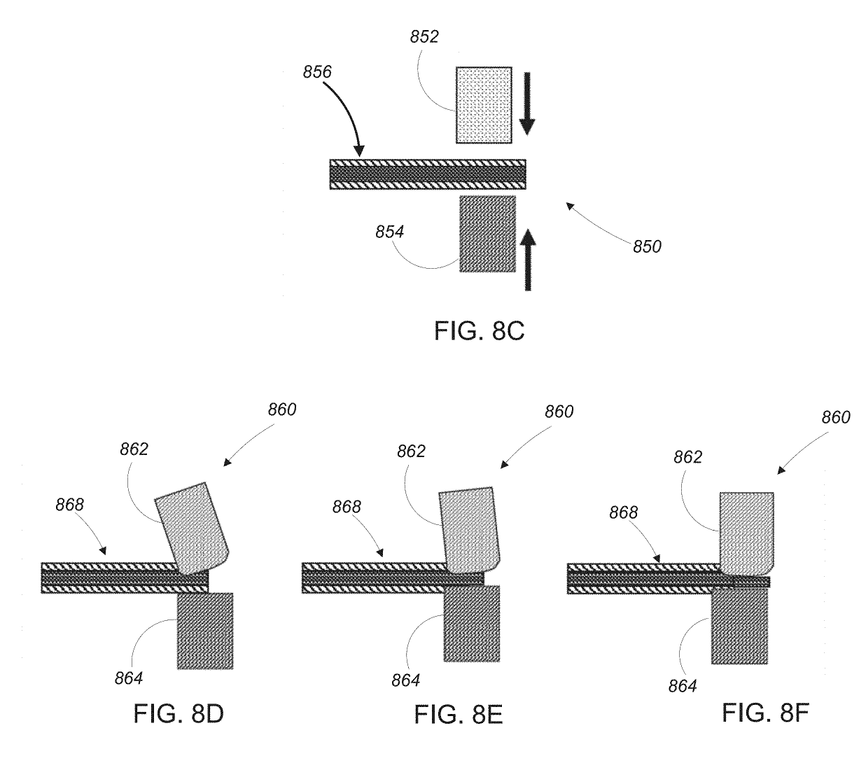

As noted, in some implementations, partial stripping of the insulating layer (e.g., subsequent to wire stripping of the shield layer) may be performed using a crimping tool that presses on a portion of the insulating layer to squeeze out and expose at least a portion of the core conducting wire. More particularly, and with reference to FIGS. 8A-B showing a schematic front view and a schematic side view of an example crimping tool 800, after stripping the conductive shield layer to expose a portion of an insulating layer surrounding a portion of the core conductive wire, the modified coaxial cable is advance to the crimping too. The crimping tool 800 may be disposed at a location between the EFO contact arm 620 and a bonding tool 640 depicted in FIG. 6. The coaxial cable may be advanced to the crimping tool 800 using the feeding and cutting mechanism 630 of FIG. 6 (e.g., before the cutting operation is performed by the cutting tool to separate the current coaxial cable section from the coaxial cable wound up on the spool). The feeding mechanism may be implemented using an apparatus similar to that shown in FIGS. 7A-C. The crimping tool 800 includes a receiving base 810 with a slot 812 defining a space to receive the coaxial cable, and a displaceable presser 820 that is matingly displaced into the slot 812 of the receiving base 810. The receiving base 810 may be stationary during the pressing operation (although the crimping tool itself may be displaceable to different locations).

When a coaxial cable 830 (which may be similar to any of the coaxial cables described herein) is advanced to the crimping tool 800 and received into the recess 812, the presser 820 is actuate to a mating position within the slot 812 of the receiving base 810, whereupon the presser 820 presses on the exposed insulating layer 836 of the coaxial cable 830 to press down insulating layer and push out a portion of the exposed core conductive wire, resulting in an exposed uninsulated core wire portion 835. Subsequently, the exposed uninsulated core wire portion 835 can be deformed (e.g., to form a ball-shaped deformation) and bonded to an electrical connection point.

FIG. 8C is a schematic side view of another example implementation of a pressing (crimping) tool 850, which includes a base 854 that is configured to be actuated and displaced towards a presser 852 (which may be similar to the presser 820 of FIGS. 8A-B). Thus, in such embodiments, both the base and presser are displaced towards each other to produce a pressing action on the coaxial cable 856 received therebetween (e.g., after being advanced by a feeding and cutting mechanism such as the mechanism 630 of FIG. 6).

FIGS. 8D-F are schematic side views of another example pressing (crimping) tool 860 in operation. The pressing tool 860 includes a pivotable presser 862 that causes the pressing and squeezing action on the coaxial cable 868 received between a base 864 and the presser 862. In these example embodiments, the base 864 and the presser 862 may both be displaceable towards each other, or, alternatively, one or both of these parts may be stationary (e.g., other than the pivoting motion that the presser undergoes). As illustrated in FIGS. 8D-F, in these example embodiments, the presser 862 may begin its pivoting motion towards the base 864 while the coaxial cable 868 (which may be similar to any of the coaxial cables described herein) is advancing through the pressing tool 860.

Turning back to FIG. 6, as further illustrated the system 600 also includes at least one bonding tool 640, which in the FIG. 6 is depicted as an thermosonic bond tool. However, the bond tool 640 may be implemented according to different types of bonding techniques/procedures, including ultrasonic welding, electron beam welding, cold welding, laser welding, resistance welding, thermosonic capillary welding, or thermosonic wedge/peg welding, soldering techniques, and/or other bonding processes.

Thus, in operation, the coaxial cable 610 (micro coaxial cable) is fed (continuously, or in response to triggers or actuations from an operator) using a feeding and cutting mechanism 630. At desired instances (which may be pre-determined instances, or instances/locations of the feed derived based on some pre-determined circuit configuration that is to be implemented), the coaxial cable 610 is cut to obtain a cable section. Before or after the cable cutting, one or more energy applicators, such as the applicators 620 and 622 (which may be EFO contact arms), apply energy to the cable to cause the conductive shield layer of the cable 610 to be controllably stripped. As noted, the level and duration of the energy applied may be controlled based on determined characteristics of the cable being processed (e.g., geometry, materials), characteristics of the environment (the ambient air composition, heating gas being dispersed to facilitate with the functionality of the system 600), and/or dynamic measurements (using sensors) of various factors and conditions of the coaxial cable (cable temperature, progress of the EFO process, as determined based on visual/image data). In some embodiments, the wire stripping operation for the conductive shield layer may also be achieved, at least in part, using mechanical stripping tools (e.g., as illustrated in FIG. 7A-B).

The application of energy by the energy applicators (e.g., the EFO contact arms 620 and 622) also causes deformation of sections of the core conductive wire that were exposed as a result of the initial application of energy. The deformations (e.g., into ‘ball-shaped’ formations) may be caused by the initial application of energy (to begin the shield layer stripping) or by subsequent energy applications. This may depend on such factors as the materials of the wires comprising the coaxial cable, the cable geometry, environmental conditions, etc. In some embodiments, the application of energy also causes sections of the stripped conductive shield layer to be deformed (into a thickened layer, such as ball-shaped deformations). The bonding tool, such as the tool 640, is applied to cause bonding of the deformed core conductive wire and/or the conductive shield layer, to be bonded to electrical connection points using one or more bonding techniques (welding, soldering, etc.)

As further discussed herein, in embodiments in which the coaxial cable includes an insulating layer, the system 600 may also be configured to cause a section(s) of the insulating layer (covering the section of the core wire that is to be bonded to the electrical connection points on the circuitry external to the cable) to be stripped. Stripping of the insulating layer may be performed as part of the energy application process (e.g., via the EFO process) or using a mechanical tool, such as the pressing/crimping tools depicted in FIGS. 8A-F. As also discussed herein, in some embodiments, the micro coaxial cable may also include a cladding layer (disposed between the core wire and the insulating layer). The cladding layer may be constructed from a brittle material, such as nickel or tungsten that, while protecting the core wire from initial heat buildup (so that only the shield layer and insulating layer are structurally modified without affecting the core wire), when the core wire finally begins to be deformed, it will break the brittle cladding layer.

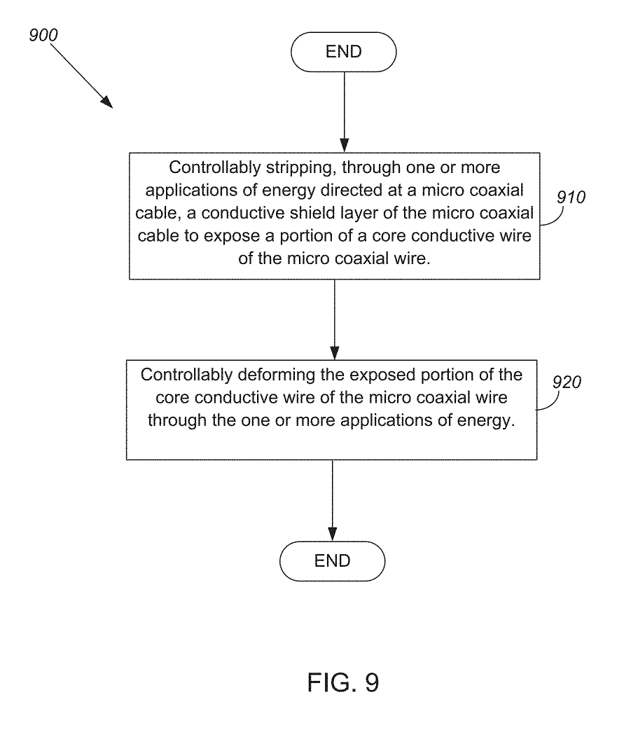

With reference now to FIG. 9, a flowchart of an example procedure 900 to perform stripping and bonding operations on a micro coaxial cable (which may be similar to operations described in relation to the processes and implementations of FIGS. 1A-D, 2A-B, 3A-D, 4A-C, 5A-C, 6, 7A-C, 8A-F, and 12A-B) is shown. As illustrated, the procedure 900 includes controllably stripping 910, through one or more applications of energy directed at a micro coaxial cable, a conductive shield layer of the micro coaxial cable to expose a portion of a core conductive wire of the micro coaxial wire. The one or more applications of energy may include one or more electrical sparks directed at the micro coaxial cable via, for example, one or more EFO contact arms (such as the EFO contact arms 620 and 622 shown in FIG. 6). In such embodiments, the procedure 900 may further include steering the one or more electrical sparks using an electromagnetic-based steering mechanism. The one or more applications of energy may include other forms of energy (e.g., optical energy, acoustic energy, etc.)

The micro coaxial wire may further include an insulating layer disposed between the core conductive wire and the conductive shield layer, with the insulating layer configured to be at least partly stripped, through the one or more applications of energy, subsequent to the stripping of the conductive shield layer so as to expose an uninsulated portion of the core conductive wire. In some variations, the insulating layer may include, for example, a polymer such as a polyimide layer surrounding the core conductive wire and/or a polyurethane layer surrounding the core conductive wire, and/or may include a silicon dioxide layer surrounding the core conductive wire. The conductive shield layer may be associated with a first melting temperature and the core conductive wire may be associated with a second melting temperature, with the first melting temperature being lower than the first melting temperature. The conductive shield layer may include a first material comprising gold, and the core conductive wire may include a second material comprising copper.

As further shown in FIG. 9, the procedure 900 also includes controllably deforming 920 the exposed portion of the core conductive wire of the micro coaxial wire through the one or more applications of energy. Controllably stripping the conductive shield layer and controllably deforming the exposed portion of the core conductive wire may include controllably applying the one or more applications of energy based on one or more of, for example, materials used for the conductive shield layer and the core conductive wire, location of an energy applying device configured to apply the one or more applications of energy, power and duration characteristics of the one or more applications of energy, geometry of the micro coaxial cable, location of grounding points to define one or more energy paths for the one or more applications of energy, measured environmental conditions, and/or sensor measurements of state of the micro coaxial cable

In some embodiments, controllably stripping the conductive shield layer may include placing one or more electrical contacts at a first location proximate the conductive shield layer, and directing a first electrical current via a first path defined, in part, by the conductive shield layer and the one or more electrical contacts placed at the first location proximate the conductive shield layer. Controllably deforming the core conductive wire may include placing at least one electrical contact at a second location proximate the core conductive wire, and directing a second electrical current via a second path defined, in part, by the core conductive wire and the at least one electrical contact placed at the second location proximate the core conductive wire.

The procedure 900 may further include deforming a portion of the stripped conductive shield layer to form a resultant thickened shield portion of the conductive shield layer configured to be coupled to a first electrical connection point located near the micro coaxial cable. Controllably deforming the exposed portion of the core conductive wire may include forming a resultant thickened core portion of the core conductive wire configured to be coupled to a second electrical connection point located near the micro coaxial cable.

In some variations, the micro coaxial wire may further include a cladding layer disposed between the core conductive wire and the conductive shield layer, with the cladding layer configured to remain substantially intact in response to the one or more applications of energy to the micro coaxial cable, with at least a portion of the cladding layer configured to break upon deformation of the exposed portion of the core conductive wire of the micro coaxial cable. The cladding layer may include a cladding material comprising one or more of, for example, nickel and/or tungsten. In some embodiments, the procedure 900 may include forming a cladding layer through the one or more applications of energy to cause a chemical reaction of a cladding material with other materials in the micro coaxial cable.

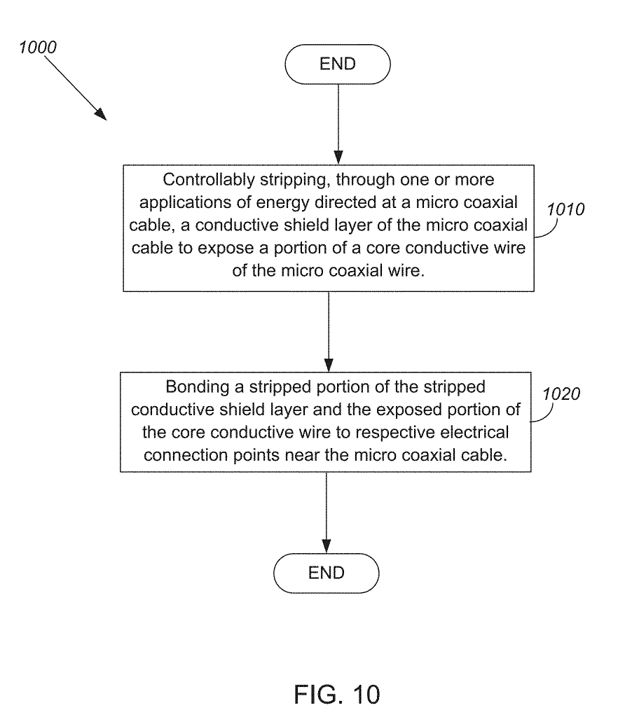

With reference now to FIG. 10, a flowchart of another example procedure 1000 to structurally control and modify a micro coaxial cable is shown. The example procedure 1000 includes controllably stripping 1010, through one or more applications of energy directed at a micro coaxial cable, a conductive shield layer of the micro coaxial cable to expose a portion of a core conductive wire of the micro coaxial wire. As noted, the one or more applications of energy may be provided via one or more EFO energy applicators (to controllably generate electrical sparks). The procedure 1000 further includes bonding 1020 a stripped portion of the stripped conductive shield layer and the exposed portion of the core conductive wire to respective electrical connection points near the micro coaxial cable. In some implementations, the procedure 1000 may further include controllably deforming an area of the exposed portion of the core conductive wire of the micro coaxial wire through the one or more applications of energy, and bonding the deformed area of the exposed portion of the core conductive wire to one of the respective electrical connection points near the micro coaxial cable.

Performing the various procedures, processes, and operations described herein may be facilitated by a controller system (e.g., a processor-based controller system, a state machine, etc.) For example, a system such as the system 600 depicted in FIG. 6 may be controlled to structurally modify a micro coaxial cable using one or more controllers such as the one shown in FIG. 11, illustrating an example controller system 1100. The controller system 1100 includes a controller device 1110 such as a computing device, a specialized computing device, a controller circuit (implemented on a chip), and so forth, that typically includes a central controller 1112 (which may a programmable processor, such as a CPU). In addition to the central controller 1112, the system includes main memory, cache memory and bus interface circuits (not shown in FIG. 11). The controller device 1110 may include a mass storage element 1114, such as a hard drive or flash drive associated with the computer system. The controller system 1100 may further include a keyboard 1416, or keypad, or some other user input interface, and a monitor 1120, e.g., an LCD (liquid crystal display) monitor, that may be placed where a user can access them. The controller system 1100 may also include one or more sensors 1130 to measure environmental conditions and/or the conditions and state of the micro coaxial cable being modified or otherwise processed. The controller system 1100 may be incorporated within a system such as the system 600 described herein, and more particularly within one or more of the modules of that system, such as the energy applicators, the cutting and feeding mechanism, the bonding tool, and/or the pressing tool.

The controller device 1110 is configured to facilitate, for example, the implementation of operations to structurally modify a micro coaxial cable such as the cables described herein. The storage device 1114 may thus include a computer program product that when executed on the controller device 1110 causes the controller device to perform operations to facilitate the implementation of procedures and operations described herein. The computing/controller-based device may further include peripheral devices to enable input/output functionality. Such peripheral devices may include, for example, a CD-ROM drive and/or flash drive (e.g., a removable flash drive), or a network connection (e.g., implemented using a USB port and/or a wireless transceiver), for downloading related content to the connected system. Such peripheral devices may also be used for downloading software containing computer instructions to allow general operation of the respective system/device. Alternatively and/or additionally, in some embodiments, special purpose logic circuitry, e.g., an FPGA (field programmable gate array), an ASIC (application-specific integrated circuit), a DSP processor, etc., may be used in the implementation of the system 1100. Other modules that may be included with the controller device 1110 are speakers, a sound card, a pointing device, e.g., a mouse or a trackball, by which the user can provide input to the controller system 1100. The controller device 1110 may include an operating system, e.g., Windows XP® Microsoft Corporation operating system, Ubuntu operating system, etc.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

Although particular embodiments have been disclosed herein in detail, this has been done by way of example for purposes of illustration only, and is not intended to be limiting with respect to the scope of the appended claims, which follow. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A method comprising:
controllably stripping, through one or more applications of energy directed at a micro coaxial cable, a conductive shield layer of the micro coaxial cable to expose a portion of a core conductive wire of the micro coaxial wire; and
controllably deforming the exposed portion of the core conductive wire of the micro coaxial wire through the one or more applications of energy.

2. The method of claim 1, further comprising:
deforming a portion of the stripped conductive shield layer to form a resultant thickened shield portion of the conductive shield layer configured to be coupled to a first electrical connection point located near the micro coaxial cable;
wherein controllably deforming the exposed portion of the core conductive wire comprises:
forming a resultant thickened core portion of the core conductive wire configured to be coupled to a second electrical connection point located near the micro coaxial cable.

3. The method of claim 1, wherein the one or more applications of energy comprises one or more electrical sparks directed at the micro coaxial cable.

4. The method of claim 3, further comprising:
steering the one or more electrical sparks using an electromagnetic-based steering mechanism.

5. The method of claim 1, wherein controllably stripping the conductive shield layer and controllably deforming the exposed portion of the core conductive wire comprise:
controllably applying the one or more applications of energy based on one or more of: materials used for the conductive shield layer and the core conductive wire, location of an energy applying device configured to apply the one or more applications of energy, power and duration characteristics of the one or more applications of energy, geometry of the micro coaxial cable, location of grounding points to define one or more energy paths for the one or more applications of energy, measured environmental conditions, or measured state values for the micro coaxial cable.

6. The method of claim 1, wherein controllably stripping the conductive shield layer comprises placing one or more electrical contacts at a first location proximate the conductive shield layer, and directing a first electrical current via a first path defined, in part, by the conductive shield layer and the one or more electrical contacts placed at the first location proximate the conductive shield layer;
and wherein controllably deforming the core conductive wire comprises placing at least one electrical contact at a second location proximate the core conductive wire, and directing a second electrical current via a second path defined, in part, by the core conductive wire and the at least one electrical contact placed at the second location proximate the core conductive wire.

7. The method of claim 1, wherein the micro coaxial wire further comprises an insulating layer disposed between the core conductive wire and the conductive shield layer, with the insulating layer configured to be at least partly stripped, through the one or more applications of energy, subsequent to the stripping of the conductive shield layer so as to expose an uninsulated portion of the core conductive wire.

8. The method of claim 7, wherein the insulating layer comprises one of: a polyimide layer surrounding the core conductive wire, a polyurethane layer surrounding the core conductive wire, or an inorganic oxide.

9. The method of claim 1, wherein the conductive shield layer is associated with a first melting temperature and the core conductive wire is associated with a second melting temperature, the first melting temperature being lower than the first melting temperature.

10. The method of claim 1, wherein the conductive shield layer includes a first material comprising gold, and wherein the core conductive wire includes a second material comprising copper.

11. The method of claim 1, wherein the micro coaxial wire further comprises a cladding layer disposed between the core conductive wire and the conductive shield layer, with the cladding layer configured to remain substantially intact in response to the one or more applications of energy to the micro coaxial cable, with at least a portion of the cladding layer configured to break upon deformation of the exposed portion of the core conductive wire of the micro coaxial cable.

12. The method of claim 11, wherein the cladding layer includes a cladding material comprising one or more of: nickel, or tungsten.

13. The method of claim 11, further comprising:
forming the cladding layer through the one or more applications of energy that causes a chemical reaction of a cladding material with other materials at or near the micro coaxial cable.

14. A micro coaxial cable comprising:
a conductive shield layer structured so that, upon one or more applications of energy directed at the micro coaxial cable, at least a portion of the conductive shield layer is stripped; and
a core conductive wire, disposed proximate the conductive shield layer, structured so that a portion of a region of the core conductive wire is exposed when the at least the portion of the conductive shield layer is stripped, and is subsequently deformed as a result of at least one of the one or more applications of energy directed at the micro coaxial cable.

15. The micro coaxial cable of claim 14, wherein the at least the portion of the conductive shield layer is structured to be stripped upon a first application of energy is directed the micro coaxial cable, and wherein the exposed portion of the region of the core conductive wire is structured to be deformed upon a second application of energy directed at the micro coaxial cable.

16. The micro coaxial cable of claim 14, wherein the stripped at least the portion of the conductive shield layer is further structured to be deformed, through the one or more applications of energy, to form a resultant thickened shield portion, configured to be coupled to a first electrical connection point located near the micro coaxial cable;
and wherein the core conductive wire structured so that the exposed portion of the region of the core conductive wire is deformed as the result of the at least one of the one or more applications of energy is structured so that the exposed portion of the region of the core conductive wire is deformed to form a resultant thickened core portion configured to be coupled to a second electrical connection point located near the micro coaxial cable.

17. The micro coaxial cable of claim 14, wherein the micro coaxial wire further comprises an insulating layer disposed between the core conductive wire and the conductive shield layer, with the insulating layer configured to be at least partly stripped, through the one or more applications of energy, subsequent to the stripping of the conductive shield layer so as to expose an uninsulated portion of the core conductive wire, and wherein the insulating layer comprises one of: a polyimide layer surrounding the core conductive wire, a polyurethane layer surrounding the core conductive wire, or an inorganic oxide dielectric.

18. The micro coaxial cable of claim 14, wherein the micro coaxial wire further comprises a cladding layer disposed between the core conductive wire and the conductive shield layer, with the cladding layer configured to remain substantially intact in response to the one or more applications of energy to the micro coaxial cable, with at least a portion of the cladding layer configured to break upon deformation of the exposed portion of the core conductive wire of the micro coaxial cable, and wherein the cladding layer includes a cladding material comprising one or more of: nickel, or tungsten.

19. A system comprising:
a micro coaxial cable comprising a core conductive wire and a conductive shield layer; and
an energy application and bonding device configured to:
controllably strip, through one or more applications of energy directed at the micro coaxial cable, the conductive shield layer of the micro coaxial cable to expose a portion of the core conductive wire of the micro coaxial wire; and
controllably deform the exposed portion of the core conductive wire of the micro coaxial wire through the one or more applications of energy.

20. The system of claim 19, wherein the energy application and bonding device is further configured to:
deform a portion of the stripped conductive shield layer to form a resultant thickened shield portion, of the conductive shield layer, configured to be coupled to a first electrical connection point located near the micro coaxial cable;
and wherein the energy application and bonding device configured to controllably deform the exposed portion of the core conductive wire is configured to form a resultant thickened core portion, of the core conductive wire, configured to be coupled to a second electrical connection point located near the micro coaxial cable.

21. The system of claim 19, further comprising:
a feeding and cutting mechanism to dispense and cut the micro coaxial cable.

22. A method comprising:
controllably stripping, through one or more applications of energy directed at a micro coaxial cable, a conductive shield layer of the micro coaxial cable to expose a portion of a core conductive wire of the micro coaxial wire; and
bonding a stripped portion of the stripped conductive shield layer and the exposed portion of the core conductive wire to respective electrical connection points near the micro coaxial cable.
